(19) United States
(12) Patent Application Publication
(10) Pub. No.: US 2004/0258216 A1
(43) Pub. Date: Dec. 23, 2004

(54) Methods and systems for routing combined communication identifiers to separate communication devices

(76) Inventor: Laura Reid, Alpharetta, GA (US)

Correspondence Address: MYERS BIGEL SIBLEY & SAJOVEC, PO BOX 37428, RALEIGH, NC, 27627, US

(21) Appl. No.: 10/465,183

(22) Filed: Jun. 19, 2003

(51) Int. Cl. H04M 7/00; H04M 11/00

(52) U.S. Cl. 379/88.13; 379/220.01

(57) ABSTRACT

A method for routing incoming communications that are directed to integrated communication manager (ICM) identifiers to communication devices. An ICM identifier is associated with a plurality of identifiers for communication devices. The association between the ICM identifier and the plurality of communication device identifiers is determined in response to an incoming communication directed to the ICM identifier. The incoming communication is routed to at least one of the communication device identifiers that is associated with the ICM identifier. Related systems are also disclosed.

### FIELD OF THE INVENTION

The present invention generally relates to communication systems, and more particularly to systems and methods for routing communications to communication devices.

### BACKGROUND

There is a general trend for people to use an increasing number and variety of communication devices. For example, a person may now communicate by a subscriber line phone, wireless cellular phone, wireless pager, wireless data terminal, facsimile device, and email. The variety of communication devices can provide more flexibility for how, when, and where a person can be contacted, but it can also increase the complexity of such communication. For example, each of these communication devices may have unique access requirements and a unique telephone number or internet address. Contacting a person who has such a variety of communication devices may involve obtaining a list of the telephone numbers or internet addresses of the communication devices and guessing as to the best way to contact the person and/or trying different devices until successful.

Some services that have been provided by network operators for facilitating contact of their subscribers who have several phone numbers (e.g., home, work, cellular) are call forwarding services, find-me/follow-me services, and voice mailbox services. A customer may use these services by defining one of the phone numbers as a “home base”, which when called, can cause other defined phone numbers to be sequentially attempted.

### SUMMARY

Various embodiments of the present invention provide a method for routing incoming communications that are directed to integrated communication manager (ICM) identifiers to communication devices. An ICM identifier is associated with a plurality of identifiers for communication devices. The association between the ICM identifier and the plurality of communication device identifiers is determined in response to an incoming communication directed to the ICM identifier. The incoming communication is routed to at least one of the communication device identifiers that is associated with the ICM identifier.

In some further embodiments of the present invention, the communication devices include one or more of a subscriber line telephone, a facsimile device, an internet connected computer, a voice mail device, a wireless telephone, a wireless terminal, and a wireless pager. The incoming communication may be simultaneously or sequentially routed to a plurality of the communication device identifiers. When the incoming communication comprises a text message, it is routed to one or more communication device identifiers that are associated with the ICM identifier and that are capable of receiving text messages. When the incoming communication comprises an audible signal, it is routed to one or more communication device identifiers that are associated with the ICM identifier and that are capable of receiving audible signals. An incoming communication that comprises a text message may be converted to an audible signal and routed to at least one of the communication devices. An incoming communication that comprises an audible signal may be converted to a text message and routed to at least one of the communication devices.

### BRIEF DESCRIPTION OF THE DRAWINGS

FIG. 1 is a block diagram of a communications system according to embodiments of the present invention.

FIG. 2 is a block diagram of an integrated communication manager service controller according to embodiments of the present invention.

FIG. 3 is a flow chart illustrated operations for routing incoming communications that are directed to ICM identifiers for communication devices according to embodiments of the present invention.

### DETAILED DESCRIPTION

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

It also will be understood that, as used herein, the term “comprising” or “comprises” is open-ended, and includes one or more stated elements, steps and/or functions without precluding one or more unstated elements, steps and/or functions.

The present invention is described below with reference to block diagrams and/or operational illustrations of methods and systems according to embodiments of the invention. It is understood that each block of the block diagrams and/or operational illustrations, and combinations of blocks in the block diagrams and/or operational illustrations, can be implemented by analog and/or digital hardware, and/or computer program instructions. These computer program instructions may be provided to a processor of a general purpose computer, special purpose computer, ASIC, and/or other programmable data processing apparatus in a system, such that the instructions, which execute via the processor of the computer and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

It should be understood, that, as used herein, the term “wireless terminal” may include a cellular radiotelephone with or without a multi-line display; a pager; a Personal Communications System (PCS) terminal that may combine a cellular radiotelephone with data processing, facsimile and data communications capabilities; a Personal Data Assistant (PDA) that can include a radiotelephone, pager, Internet/intranet access, Web browser, organizer, calendar and/or a global positioning system (GPS) receiver; and a conventional laptop and/or palmtop portable computer that includes a radiotelephone or other transceiver.

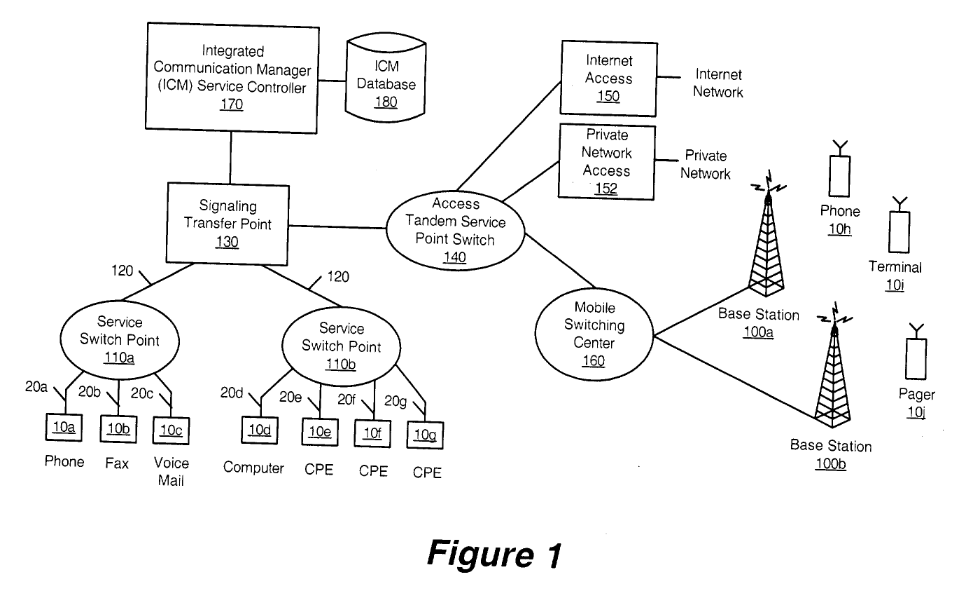

FIG. 1 is a block diagram of a system for routing communications between communication devices according to various embodiments of the present invention. The representative communication devices shown in FIG. 1 include a phone 10a, facsimile device 10b, voice mail device 10c, computer 10d, consumer premises equipment (CPE) 10e-g that are connected to the system by subscriber telephone lines 20a-g, a wireless phone 10h, wireless terminal 10i, and wireless pager 10j that are connected to the system by wireless communication channels serviced by base stations 100a-b. It will be understood that each subscriber telephone lines 20a-g may connect a plurality of communication devices to the SSPs 110a-b.

A plurality of central office switches are equipped with service switch points (SSPs) that serve as gateways between Communication devices that are connected to serviced subscriber telephone lines 20a-g and the rest of the communication system.

For example, representative SSPs 110a-b route communications to, from, and/or between the communication devices 110a-c and 110d-g, respectively, via subscriber telephone lines 20a-c and 20d-g, respectively. The SSPs 110a-b can be interconnected by a network of high capacity circuits known as “trunks”, which are commonly designated 120, and a signaling transfer point 130. An access tandem service point switch 140 may connect the signaling transfer point 130 to an internet access device 150, a private network access device 152, and to a mobile switching center 160. The internet access device 150 can be connected to one or more internet networks. The private network access device 152 can be connected to one or more private data communication networks, which can include, but are not limited to, an asynchronous transfer mode (ATM) data network, Ti data network, cable data network, digital subscriber line (DSL) data network, and/or wireless data network. The mobile switching center 160 can route communications among the wireless phone 110h, wireless terminal 10i, and/or wireless pager 110j that are serviced by the base stations 100a-b, and can serve as a gateway for routing communications to the internet access device 150, the private network access device 152, and the subscriber telephone lines 20a-g via the access tandem service point switch 140.

Each of the subscriber telephone lines 20a-g should be assigned a unique telephone number. Each of the SSPs 110a-b may include sufficient memory to store a local database of the telephone numbers assigned to the serviced subscriber telephone lines 20a-c and 20d-g, respectively. Similarly, each of the wireless Communication devices 10h-10j are assigned a unique telephone number, and the mobile switching center 160 may store a local database of the serviced telephone numbers.

For example, the phone 10a may be used to dial a phone number that is assigned to the wireless phone 110h. The SSP 110a identifies the phone number as outside of its serviced lines 20a-c and routes the communication to the signaling transfer point 130, which routes the communication through the access tandem service point switch 140 to the mobile switching center 160. The mobile switching center 160 determines that the wireless phone 10h is serviced by the base station 100a, and attempts to establish a wireless communication link to the wireless phone 10h.

The system can also be used to route communications that are directed to integrated communication manager (ICM) identifiers. ICM identifiers are associated with a plurality of identifiers for communication devices, such as, for example, the unique phone numbers and internet addresses of communication devices 10aj. An ICM identifier may be a string of numbers, such as, for example, a 10 digit number, letters, or a combination of numbers and letters. Unlike the identifiers for the communications devices, the ICM identifier may or may not be an identifier for a communication device itself, but instead may provide a logical association from the ICM identifier to a plurality of communication device identifiers. The exemplary system further includes an ICM service controller 170 and an ICM database 180 that are used to route communications that are directed to ICM identifiers. Associations between ICM identifiers and identifiers for communication devices are stored in the ICM database 180. The associations may be defined by, for example, assigning an ICM identifier to a subscriber, and allowing the subscriber to define what communication device identifiers are to be associated with the ICM identifier. For example, the system may be configuring to allow the user to call and/or log into the system via the internet to define such associations.

The associations between the ICM identifiers and the communication device identifiers can also include policies that may be defined by the subscriber. Access to the communication device identifiers for an incoming communication may then be based on the policies. The policies can include associating known sources of incoming communications (e.g., callers) with certain ones of the communication device identifiers. For example, a family member may be associated with, and have access, to all of a subscriber's communication device identifiers, while someone from work may have more limited access to only a defined subset of the communication device identifiers. The policies may also change based on, for example, the time of day, day of week, date, and/or based on information provided in the incoming communication, such as, for example, a priority indication (e.g., low, medium, high priority). The policies can also define whether an incoming communication is to be simultaneously routed to all or some of the communication device identifiers, or routed sequentially, such as, for example, until communication with one of the communication device identifiers is successfully initiated or completed (e.g., not busy or otherwise unavailable).

Other policies may define what to do with an incoming communication if no communication devices that are associated with the incoming ICM identifier are available. Referring to FIG. 1, the phone 10a, voice mail 10c, and wireless phone 10h may be, for example, capable of receiving communications that contain audible signals (e.g., speech or other signal that can be output to a speaker) but not those containing text messages or facsimile data. The computer 10d and wireless pager 10j may be capable of receiving communications that contain text messages but not those containing audible signals or facsimile data. The facsimile device 10b may be capable of only receiving communications containing facsimile data, and the wireless terminal 10i may be capable or receiving audio signals, text messages, and facsimile data. As used herein, the availability of a communication device may be based on, for example, it capabilities, policies that are associated with the ICM identifier, and/or whether the communication device is busy, turned-off, or otherwise inaccessible.

When one of the SSPs 110a-b receives a communication that is directed to an ICM identifier, it routes the communication through the Signaling Transfer Point 130 to the ICM service controller 170. Similarly, when a communication directed to an ICM identifier is received by the Internet Access device 150 or the Mobile Switching Center 160, it is routed through the Access Tandem Service Point Switch 140 and the Signaling Transfer Point 130 to the ICM service controller 170. The ICM service controller 170 determines the association between the ICM identifier and the communication device identifiers, such as by querying the ICM database 180, and routes the communication to one or more of the communication devices associated with the ICM identifier. The routing of the communication may be, for example, based on policies that are associated with the ICM identifier, and may be simultaneously or sequentially performed as described above.

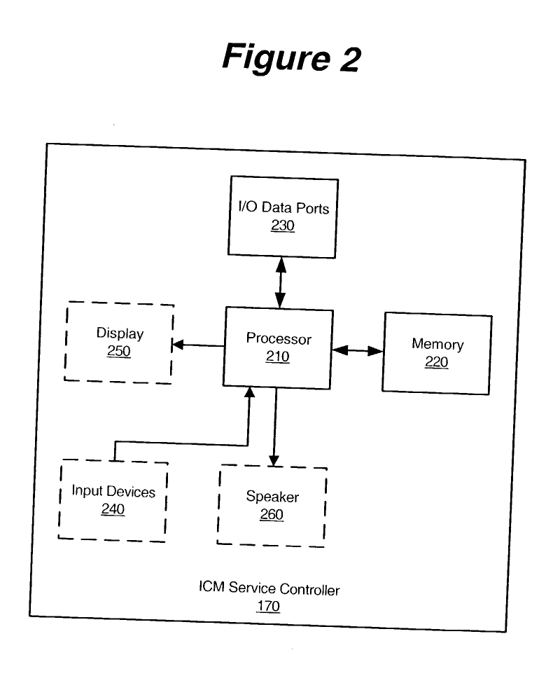

FIG. 2 shows a block diagram of an exemplary embodiment of a ICM service controller 170 suitable for routing communications that are directed to an ICM identifier. The ICM service controller 170 includes a processor 210 that communicates with a memory 220 and I/O data ports 230. The processor 210 communicates with the ICM database 180 and with the Signaling Transfer Point 130 through the I/O data ports 230. The ICM service controller 170 may, optionally, include input device(s) 240 such as a keyboard or keypad, a display 250, and speaker 260 (illustrated in dashed lines) that also communicate with the processor 210. These components may be conventional components such as those used in many conventional computer systems which may be configured to operate as described herein.

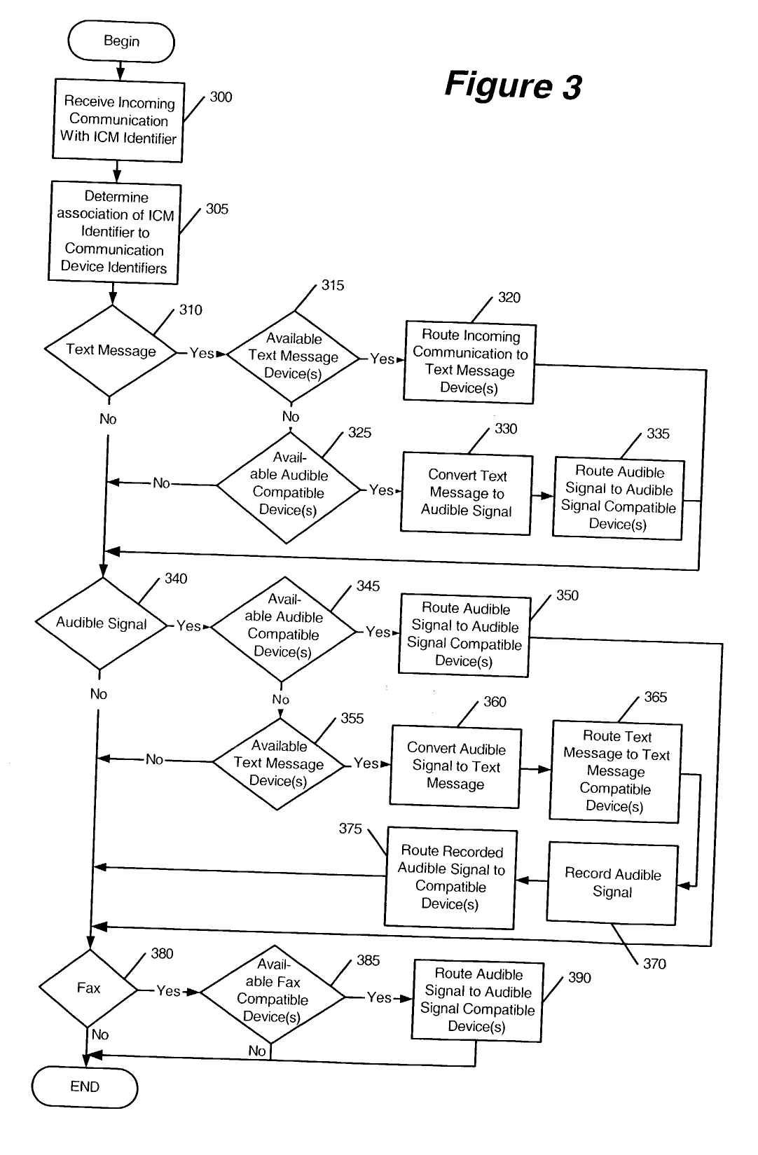

FIG. 3 is a flow chart that shows exemplary operations that may be performed by, for example, the ICM service controller 170 alone or in combination with other components such as the ICM database 180 and/or the signaling transfer point 130, for routing incoming communications that are directed to an ICM identifier to communication devices via their identifiers.

At Block 300, an incoming communication is received that is directed to an ICM identifier. Identifiers for communication device that are associated with the ICM identifier are determined at Block 305. A determination is made at Block 310 as to whether the incoming communication is a text message. If it is a text message, a determination is made at Block 315 as to whether any of the associated communication devices that are capable of receiving text messages are available, and, if available, the incoming communication is routed, at Block 320, to one or more of the available communication devices.

If no text message capable communication devices are available, at Block 315, a determination is then made at Block 325 as to whether any communication devices are available that are capable of receiving audible signals. If available, the text message is converted, at Block 330, to an audible signal by, for example, a conventional text-to-speech program and/or circuitry, and is routed, at Block 335, to one or more of the available communication devices.

At Block 340, a determination is made as to whether the incoming communication contains an audible signal. If it does, a further determination is made, at Block 345, as to whether any of the communication devices are available that are capable of receiving an audible signal, and, if available, the communication is routed, at Block 350, to one or more of the available communication devices. If unavailable, at Block 345, a determination is made at Block 355 as to whether communication devices are available that are capable of receiving a text message. If they are available, the audible signal is converted, at Block 360, to a text message by, for example, converting speech in the audible signal using a conventional speech to text program and/or circuitry. At Block 365 the text message is routed to one of more of the available text capable communication devices. At Block 370, the audible signal may also, or instead of the conversion at Block 360, be recorded. The recorded signal is then routed at Block 375 to one or more of the available text capable communication devices by, for example, creating a text message (e.g., email) that includes the recorded signal. The recorded signal may be in a conventional audio format such as, for example, MP3, WAV, and/or MPEG. As will be appreciated, Blocks 360, 365, 370, and 375 may be combined into alternative operations, such as, for example, converting audible signals to a text message and routing, or recording a message and routing the recorded message.

At Block 380, a determination is made as to whether the incoming communication is a facsimile, and, if it is, a determination is made at Block 385 as to whether one or more communication devices are available that are capable of receiving facsimile communications. If available, the communication is routed at Block 390 to one or more of the available communication devices.

Upon completion of the routing of an incoming communication to communication devices and/or upon a failure to complete such routing, a source of the incoming communication may be notified of the status of the routing. When the routing failed to complete, the notification may provide alternative ways for contacting a user who is associated with the ICM identifier. The system may then allow the source of the communication to attempt these alternative ways by, for example, raising a priority that is associated with the communication.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed:

1. A method of routing incoming communications that are directed to integrated communication manager (ICM) identifiers for communication devices, the method comprising:
associating an ICM identifier with a plurality of identifiers for communication devices;
determining the association between the ICM identifier and the plurality of communication device identifiers in response to an incoming communication directed to the ICM identifier; and
routing the incoming communication to at least one of the plurality of communication device identifiers that are associated with the ICM identifier.

2. The method of claim 1, wherein the plurality of communication devices comprise at least one of a subscriber line telephone, a facsimile device, an internet connected computer, a voice mail device, a wireless telephone, a wireless terminal, and a wireless pager.

3. The method of claim 2, wherein associating an ICM identifier with a plurality of communication devices comprises associating the ICM identifier with a subscriber line telephone number and a wireless telephone number.

4. The method of claim 2, wherein associating an ICM identifier with a plurality of communication devices comprises associating the ICM identifier with a subscriber line telephone number and an internet address.

5. The method of claim 1, wherein routing the incoming communication to at least one of the plurality of communication device identifiers comprises simultaneously routing the incoming communication to a plurality of the communication device identifiers.

6. The method of claim 1, wherein routing the incoming communication to at least one of the plurality of communication device identifiers comprises sequentially routing the incoming communication to a plurality of the communication device identifiers.

7. The method of claim 1, wherein determining the association between the ICM identifier and the plurality of communication device identifiers comprises:
determining that the incoming communication comprises a facsimile message;
identifying a facsimile device among the plurality of communication device identifiers that are associated with the TCM identifier; and
routing the facsimile message to the identified facsimile device.

8. The method of claim 1, wherein determining the association between the ICM identifier and the plurality of communication device identifiers comprises:
determining that the incoming communication comprises a text message; and
routing the text message to at least of an internet address that is associated with the ICM identifier, a telephone number for a mobile terminal that is associated with the ICM identifier, a telephone number for a pager that is associated with the ICM identifier; and an internet address that is associated with the ICM identifier.

9. The method of claim 1, further comprising:
determining that the incoming communication comprises a text message;
converting the text message to an audible signal; and
routing the audible signal to at least one of the plurality of communication device identifiers that are associated with the ICM identifier.

10. The method of claim 9, further comprising determining availability of one or more of the plurality of communication devices associated with the ICM identifier that is capable of receiving a text message, and wherein the converting the text message to an audible signal is selectively based on the availability determination.

11. The method of claim 9, further comprising routing the audible signal to at least one of a landline phone and a wireless phone.

12. The method of claim 9, wherein the text message is an email message.

13. The method of claim 9, wherein the text message is a wireless data message.

14. The method of claim 1, further comprising:
determining that the incoming communication comprises an audible signal;
recording the audible signal; and
routing the recorded audible signal to at least one of the plurality of communication device identifiers that are associated with the ICM identifier.

15. The method of claim 14, further comprising determining availability of one or more of the plurality of communication devices that are associated with the ICM identifier and that are capable of receiving an audible signal, and wherein the recording the audible signal is selectively based on the availability determination.

16. The method of claim 14, further comprising:
creating an email message that includes the recorded audible signal; and
routing the email message to an internet address that is associated with the ICM identifier.

17. The method of claim 1, further comprising:
determining that the incoming communication comprises an audible speech signal;
converting the audible speech signal to a text message; and
routing the text message to at least one of the plurality of communication device identifiers that are associated with the ICM identifier.

18. The method of claim 17, further comprising determining availability of one or more of the plurality of communication devices that are associated with the ICM identifier and that are capable or receiving an audible speech signal, and wherein the converting the audible speech signal to a text message is selectively based on the availability determination.

19. The method of claim 17, further comprising:
creating an email message that includes the text message; and
routing the email message to an internet address that is associated with the ICM identifier.

20. The method of claim 17, further comprising:
creating a facsimile message that includes the text message; and
routing the facsimile message to a facsimile device at a telephone number that is associated with the ICM identifier.

21. The method of claim 1, further comprising:
determining availability of the at least one of the plurality of communication devices that is associated with the ICM identifier; and
responding to a source of the incoming communication with an alternative way to contact a user that is associated with the ICM identifier.

22. The method of claim 1, further comprising:
associating policies with the ICM identifier, and wherein the routing the incoming communication to at least one of the plurality of communication device identifiers is based on the policies that are associated with the ICM identifier.

23. The method of claim 22, wherein the policies are based on associating a priority with known possible sources of incoming communications.

24. The method of claim 22, wherein the policies are based on at least one of time of day, day of week, and date.

25. A system for routing incoming communications that are directed to integrated communication manager (ICM) identifiers to communication devices, the system comprising:
a plurality of communication devices, each having an identifier;
a switch configured to selectively provide communications between the communication devices; and
an ICM service controller that is configured to determine an association between an ICM identifier of an incoming communication to the switch and the plurality of communication device identifiers, and to route the incoming communication to at least one of the communication device identifiers that is associated with the ICM identifier.

26. The system of claim 25, wherein the plurality of communication devices comprise at least one of a subscriber line telephone, a facsimile device, an internet connected computer, a voice mail device, a wireless telephone, a wireless terminal, and a wireless pager.

27. The system of claim 25, wherein the ICM service controller is further configured to determine that the incoming communication comprises a text message, and is configured to route the text message to at least one of the communication device identifiers that is associated with the ICM identifier and that is capable of receiving a text message.

28. The system of claim 25, wherein the ICM service controller is further configured to determine that the incoming communication comprises a text message, and is configured to convert to the text message to an audible signal, and is configured to route the audible signal to at least one of the communication device identifiers that is associated with the ICM identifier.

29. The system of claim 25, wherein the ICM service controller is further configured to determine that the incoming communication comprises an audible signal, and is configured to record the audible signal, and is configured to route the recorded audible signal to at least one of the communication device identifiers that is associated with the ICM identifier.

30. The system of claim 25, wherein the ICM service controller is further configured to determine that the incoming communication comprises an audible signal, and is configured to convert the audible signal to a text message, and is configured to route the text message to at least one of the communication device identifiers that is associated with the ICM identifier.
